(19) United States
(12) Patent Application Publication
(10) Pub. No.: US 2007/0239834 A1
(43) Pub. Date: Oct. 11, 2007

(54) Sortable address list for email

(75) Inventors: Hong Ji, Raleigh, NC (US); Thomas R. Haynes, Apex, NC (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/400,841

(22) Filed: Apr. 10, 2006

(51) Int. Cl. G06F 15/16; G06F 3/00

(52) U.S. Cl. 709/206; 715/739

(57) ABSTRACT

The present invention provides for the sorting of an address list associated with an email. A method in accordance with an embodiment of the present invention includes: actuating a selection mechanism associated with the email; sorting a plurality of email addresses in the email in response to the actuation of the selection mechanism; and displaying the sorted email addresses.

### BACKGROUND OF THE INVENTION

1. Field of the Invention

The present invention generally relates to electronic mail (email), and more specifically relates to the sorting of an address list associated with an email.

2. Related Art

When sending or receiving an email that is addressed to multiple recipients, the sender/recipient of the email is often presented with a long list of email addresses in the “To:” or “cc:” fields associated with the email. The email addresses in the address list are often listed in alphabetical order, listed in the order the addresses were typed, or listed in the order set forth in a group distribution list. To this extent, it can be difficult for the sender/recipient of the email to scan/parse the address list to determine, for example, whether a certain person is in the address list, which company domain names are represented in the address list, etc.

### SUMMARY OF THE INVENTION

The present invention provides a sortable address list for email.

A first aspect of the present invention is directed to a method for providing a sortable address list for an email, comprising: actuating a selection mechanism associated with the email; sorting a plurality of email addresses in the email in response to the actuation of the selection mechanism; and displaying the sorted email addresses.

A second aspect of the present invention is directed to a system for providing a sortable address list for an email, comprising: a system for actuating a selection mechanism associated with the email; a system for sorting a plurality of email addresses in the email in response to the actuation of the selection mechanism; and a system for displaying the sorted email addresses.

A third aspect of the present invention is directed to a program product stored on a computer readable medium for providing a sortable address list for an email, the computer readable medium comprising program code for performing the steps of: actuating a selection mechanism associated with the email; sorting a plurality of email addresses in the email in response to the actuation of the selection mechanism; and displaying the sorted email addresses.

A fourth aspect of the present invention is directed to a method for deploying an application for providing a sortable address list for an email, comprising: providing a computer infrastructure being operable to: actuate a selection mechanism associated with the email; sort a plurality of email addresses in the email in response to the actuation of the selection mechanism; and display the sorted email addresses

The illustrative aspects of the present invention are designed to solve the problems herein described and other problems not discussed

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative received email in accordance with an embodiment of the present invention.

FIG. 2 depicts the email of FIG. 1 together with an illustrative table containing sortable email address information in accordance with an embodiment of the present invention.

FIG. 3 depicts an illustrative preference dialog for configuring a table containing sortable email address information in accordance with an embodiment of the present invention.

FIG. 4 depicts the email of FIG. 1 together with an illustrative table containing sortable email address information in accordance with an embodiment of the present invention.

FIG. 5 depicts the email of FIG. 1 together with an illustrative table containing sortable email address information and a window for displaying additional information for an email address in accordance with an embodiment of the present invention.

FIG. 6 depicts the composing of an email in accordance with an embodiment of the present invention.

FIG. 7 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

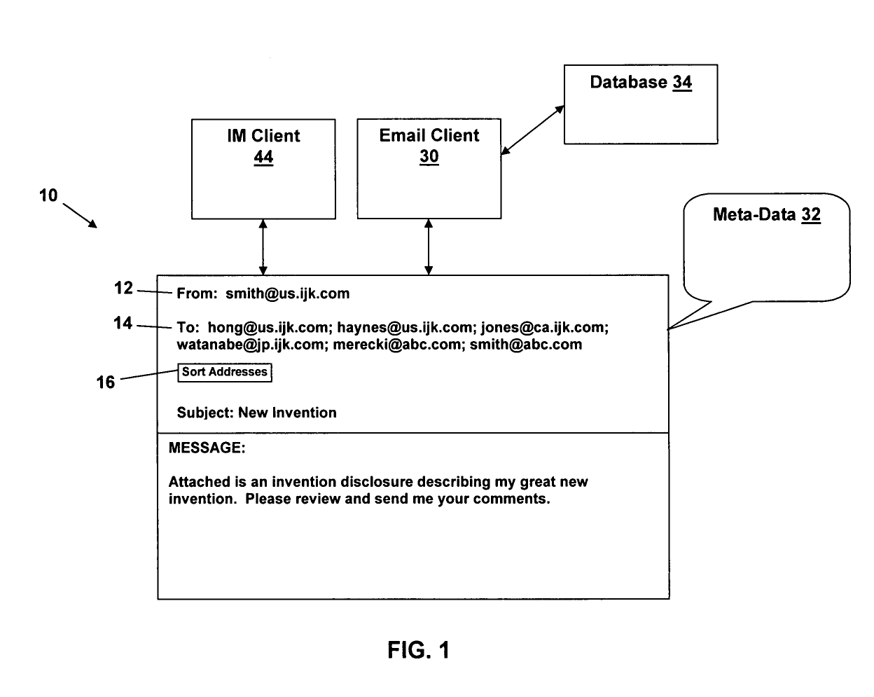

An illustrative received email 10 in accordance with an embodiment of the present invention is depicted in FIG. 1. In this example, the email 10 was sent from the email address “smith@us.ijk.com,” which is listed in the “From:” field 12, to a plurality of recipients, whose email addresses are listed in the “To:” field 14. As shown, the email addresses of the recipients include: “hong@us.ijk.com,” “haynes@us.ijk.com,” “jones@ca.ijk.com,” “watanabe@jp.ijk.com,” “merecki@abc.com,” and “jones@abc.com.”

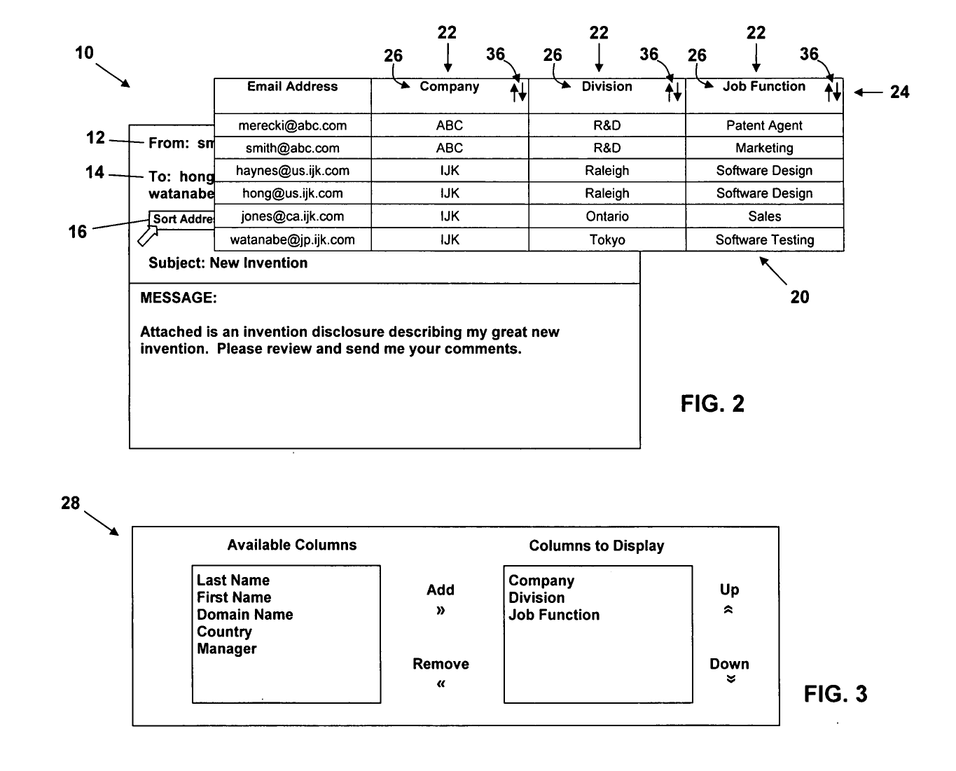

The email 10 further includes a “Sort Addresses” button 16, or other suitable selection mechanism (e.g., menu item), for actuating a sorting operation. As shown in FIG. 2, when the “Sort Addresses” button 16 is actuated (e.g., via a mouse click or keyboard shortcut), a table 20 having a plurality of attribute columns 22 is displayed. The heading 24 of each attribute column 22 includes a sorting criterion 26, which can be configured by a user. For example, as shown in FIG. 2, the sorting criterion 26 for an attribute column 22 can include “Company,” “Division,” or “Job Function.” Many other types of sorting criteria 26 are possible, and the above-examples are not meant to be limiting in any way. As shown in FIG. 3, a user can be provided (e.g., via a preference dialog 28) with a choice of the attribute columns 22 to be included in the table 20, as well as a choice of the display order (e.g., from left to right) of each included attribute column 22.

The data used to populate the cells in the table 20 can be provided in many different ways. One way involves the parsing of an email address (e.g., by an email client 30 (FIG. 1)). For example, given an email address, such as “hong@us.ijk.com,” both the company (i.e., IJK) and the country of origin (i.e., US) can easily be determined by parsing the domain name “us.ijk.com” associated with the email address. Information related to an email address can also accompany a corresponding email 10 as behind-the-scenes “meta data,” 32 (FIG. 1) and can be extracted therefrom (e.g., by the email client 30). Further, information related to an email address can be retrievable on-demand (e.g., by the email client 30), for example when a new sort is requested/initiated, via database 34 lookup. Other mechanisms for obtaining/providing the information are also possible.

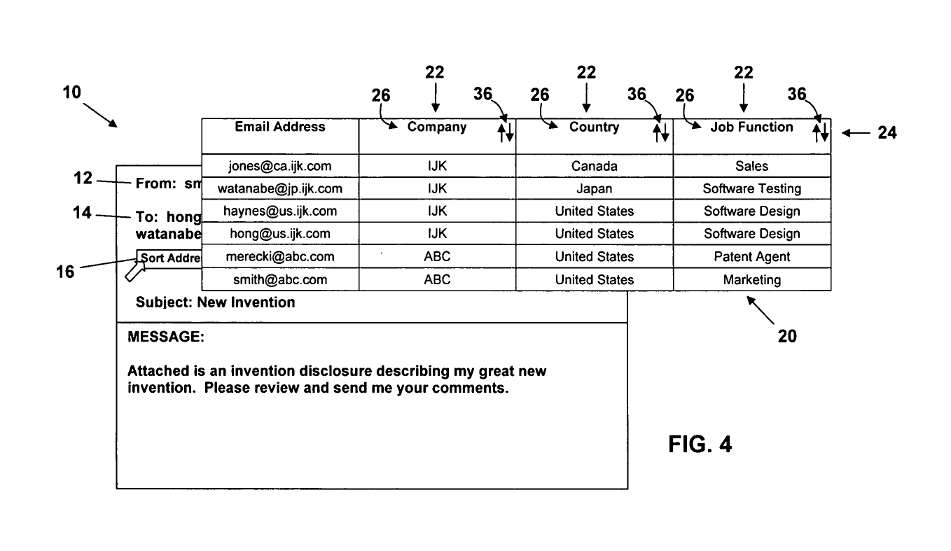

The heading 24 of each attribute column 22 further includes a sorting mechanism 36. For example, as shown, the sorting mechanism 36 can include up/down arrow buttons “T” “I” for sorting the data in the rows of the table 20 in ascending/descending order (e.g., numerically, alphabetically, etc.) based on the data in an associated attribute column 22. Many other suitable symbols, text, or other indicia (e.g., up/down triangles “▴” “▾”, text such as “up” and “down,” etc.) could also be used. In FIG. 2, the data in the table 20 has been sorted alphabetically based on the data in the “Company” attribute column 22 in response to an actuation of the corresponding sorting mechanism 36. Contrastingly, in FIG. 4, the data in the table 20 has been sorted alphabetically based on the data in the “Country” attribute column 22 in response to an actuation of the corresponding sorting mechanism 36. In this instance, the table 20 has been modified (e.g., via the preference dialog 28 (FIG. 3)) to remove the “Division” column attribute 22 and to add the “Country” column attribute 22 in its place.

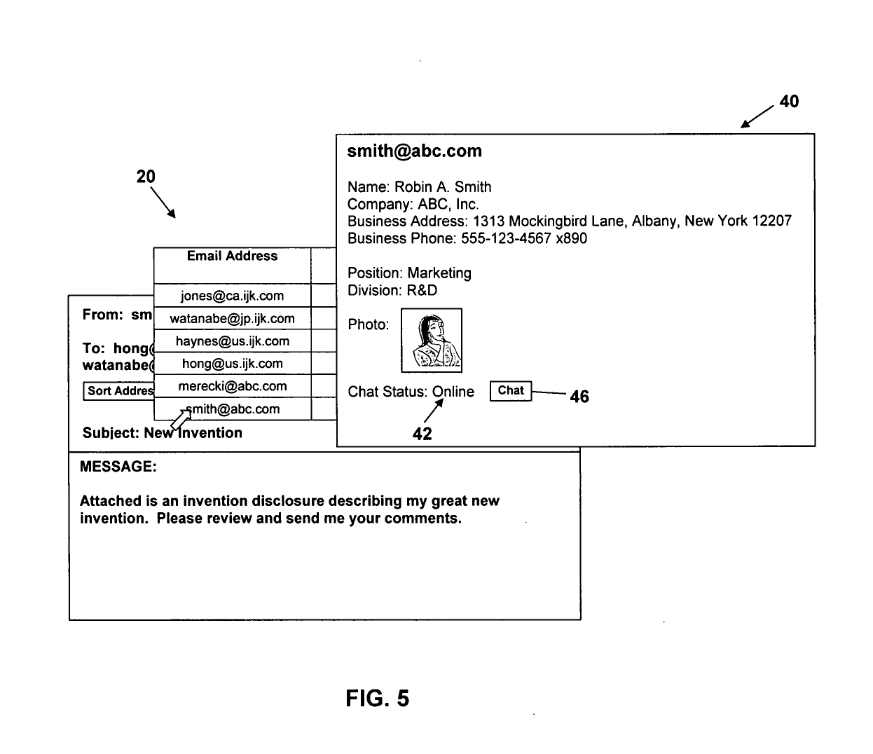

In accordance with another embodiment of the present invention, each email address listed in the “Email Address” column of the table 20 can be selected by a user in order to display additional details regarding the person associated with the email address. This functionality can be provided, for example, by making each email address listed in the “Email Address” column of the table 20 “clickable” (e.g., as a hyperlink). Other selection methodologies are also possible. For instance, as shown in FIG. 5, when the email address corresponding to “smith@abc.com” is “clicked-on” or otherwise selected, a window 40 opens and displays additional information regarding the person “Robin A. Smith” associated with that email address.

The chat status 42 of the person “Smith” associated with the email address “smith@abc.com” can also be provided in the window 40. If the chat status 42 is “Online” as shown, an instant messaging (IM) chat can be instantiated (e.g., using an IM client 44 (FIG. 1)) with the person “Smith” by actuating a “Chat button 46.”

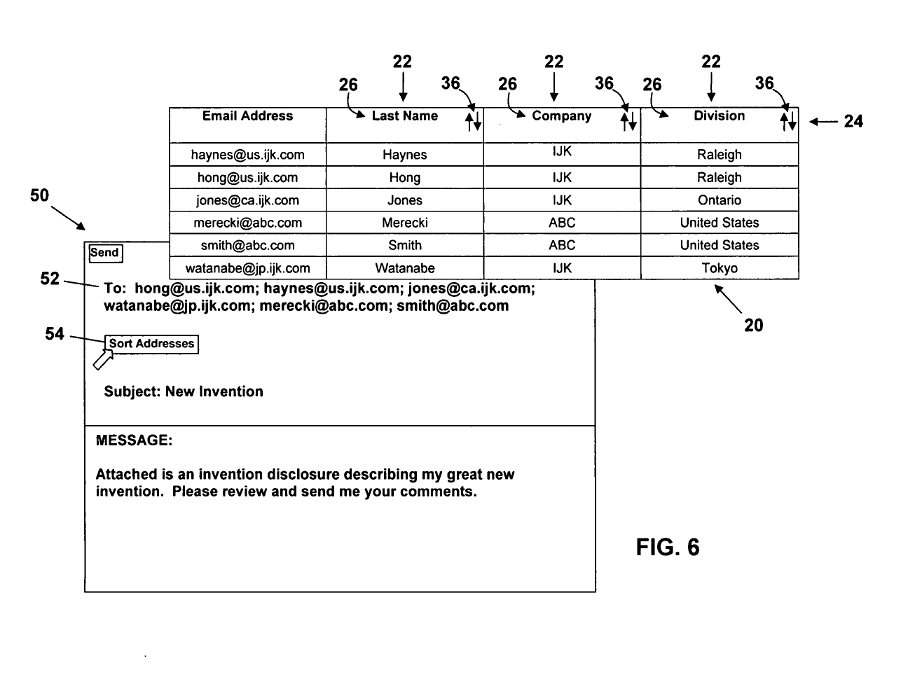

The above-described functionality with regard to a received email message can also be employed when composing an email. For instance, FIG. 6 illustrates the composition of an email 50 (e.g., using email client 30 (FIG. 1)). The email 50 includes a “To:” field 52 in which the email addresses of the intended recipients of the email 50 are listed. In this example, the email addresses of the intended recipients of the email 50 include: “hong@us.ijk.com,” “haynes@us.ijk.com,” “jones@ca.ijk.com,” “watanabe@jp.ijk.com,” “merecki@abc.com,” and “jones@abc.com.”

The email 50 further includes a “Sort Addresses” button 54, which when actuated, causes a table 20 to be displayed. As detailed above, the table 20 includes a plurality of attribute columns 22, wherein the heading 24 of each attribute column 22 includes a user-configurable sorting criterion 26. In FIG. 6, for example, the sorting criteria 26 for the attribute columns 22 includes “Last Name,” “Company,” and “Division,” and the data in the table 20 has been sorted alphabetically based on the data in the “Last Name” attribute column 22 in response to an actuation of the corresponding sorting mechanism 36. The attribute columns 22 displayed by the table 20 can be modified, as shown in FIG. 3, using a preference dialog 28. The email addresses listed in the “Email Address” column of the table 20 can be selected by a user in order to display additional details regarding the person associated with the email address (see, e.g., window 40, FIG. 5, and associated description). The table 20 can be used by the sender of the email 50, for example, to ensure that certain recipient groups are not under-represented and to identify duplicate email addresses to prevent recipients from receiving more than one copy of the email. Many other uses of the table 20, both in terms of received and sent emails, are possible.

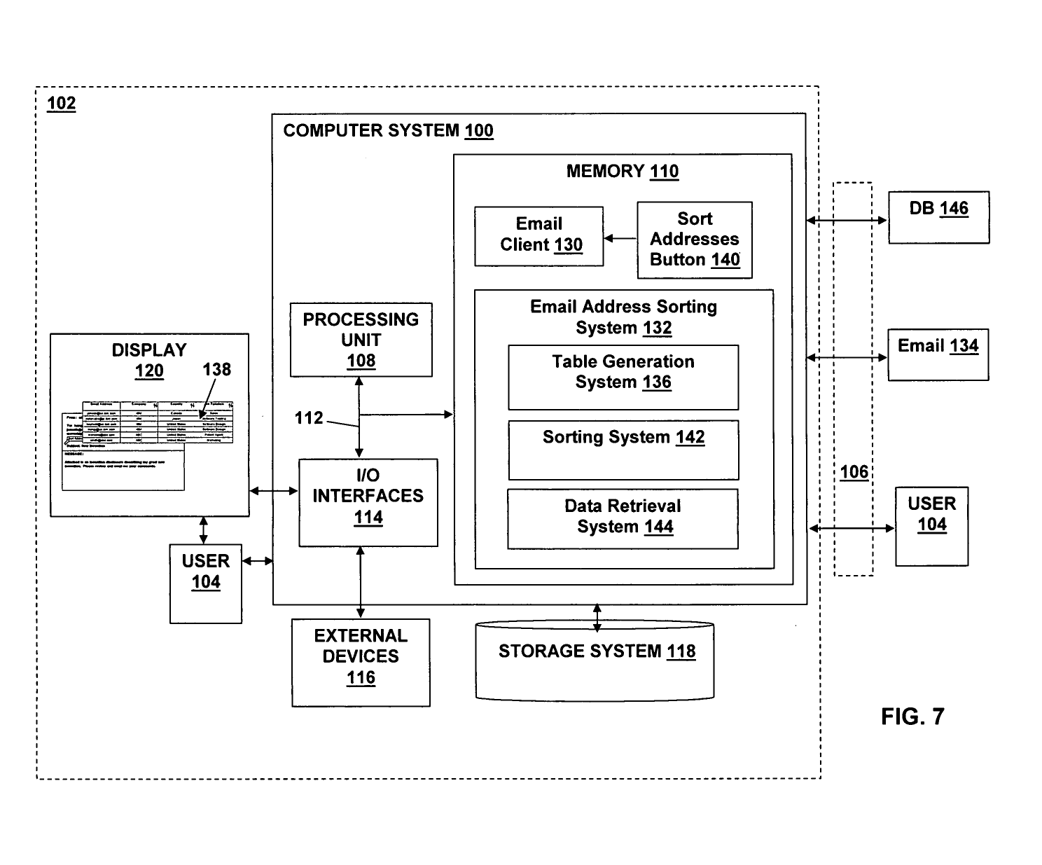

A computer system 100 for providing a sortable address list for email in accordance with an embodiment of the present invention is depicted in FIG. 7. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a sortable address list for email in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as email client 130 and email address sorting system 132, stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 7 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is an email client 130 for composing, sending, and receiving email 134, and an email address sorting system 132 for providing a sortable address list for email in accordance with the present invention, as described above. The email address sorting system 132 includes a table generation system 136 for generating a table 138 having a plurality of attribute columns in response to the actuation of a “Sort Addresses” button 140, and a sorting system 142 for sorting the data in the table 138. A data retrieval system 144 is also provided to obtain additional details regarding a person associated with an email 134 using, for example, information provided with an email 134, information retrieved from storage system 118, and/or information retrieved from external database(s) 146.

The present invention can be offered as a business method on a subscription or fee basis. For example, one or more components of the present invention can be created, maintained, supported, and/or deployed by a service provider that offers the functions described herein for customers. That is, a service provider can be used to provide a sortable address list for email, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible.

1. A method for providing a sortable address list for an email, comprising:
actuating a selection mechanism associated with the email;
sorting a plurality of email addresses in the email in response to the actuation of the selection mechanism; and
displaying the sorted email addresses.

2. The method of claim 1, wherein the selection mechanism comprises a button.

3. The method of claim 1, wherein the sorting further comprises:
setting a sorting criterion; and
sorting the plurality of email addresses based on the sorting criterion.

4. The method of claim 1, wherein the displaying further comprises:
displaying the sorted email addresses in a table.

5. The method of claim 1, wherein the email comprises a received email.

6. The method of claim 1, wherein the email comprises an email to be sent.

7. The method of claim 1, further comprising:
obtaining data associated with each of the email addresses.

8. The method of claim 7, wherein the sorting further comprises:
sorting the plurality of email addresses based on at least a portion of the data.

9. The method of claim 7, wherein the obtaining further comprises:
obtaining the data by parsing the email addresses.

10. The method of claim 7, wherein the obtaining further comprises:
obtaining the data from meta data provided with the email.

11. The method of claim 7, wherein the obtaining further comprises:
obtaining the data from an external source.

12. A system for providing a sortable address list for an email, comprising:
a system for actuating a selection mechanism associated with the email;
a system for sorting a plurality of email addresses in the email in response to the actuation of the selection mechanism; and
a system for displaying the sorted email addresses.

13. The system of claim 12, wherein the selection mechanism comprises a button.

14. The system of claim 12, wherein the system for sorting further comprises:
a system for setting a sorting criterion; and
a system for sorting the plurality of email addresses based on the sorting criterion.

15. The system of claim 12, wherein the system for displaying displays the sorted email addresses in a table.

16. The system of claim 12, wherein the email comprises a received email.

17. The system of claim 12, wherein the email comprises an email to be sent.

18. The system of claim 12, further comprising:
a system for obtaining data associated with each of the email addresses.

19. The system of claim 18, wherein the system for sorting further comprises:
a system for sorting the plurality of email addresses based on at least a portion of the data.

20. The system of claim 18, wherein the system for obtaining further comprises:
a system for obtaining the data by parsing the email addresses.

21. The system of claim 18, wherein the system for obtaining further comprises:
a system for obtaining the data from meta data provided with the email.

22. The system of claim 18, wherein the system for obtaining further comprises:
a system for obtaining the data from an external source.

23. A program product stored on a computer readable medium for providing a sortable address list for an email, the computer readable medium comprising program code for performing the steps of:
actuating a selection mechanism associated with the email;
sorting a plurality of email addresses in the email in response to the actuation of the selection mechanism; and
displaying the sorted email addresses.
